(19) United States
(12) Patent Application Publication
(10) Pub. No.: US 2012/0291454 A1
(43) Pub. Date: Nov. 22, 2012

(54) Thermoelectric Devices Using Sintered Bonding

(75) Inventors: Julian Kahler, Braunschweig (DE); Thomas Kruspe, Wietzendorf (DE); Sebastian Jung, Isernhagen (DE); Andrej Stranz, Braunschweig (DE); Andreas Waag, Braunschweig (DE); Erwin Peiner, Braunschweig (DE)

(73) Assignee: BAKER HUGHES INCORPORATED, HOUSTON, TX (US)

(21) Appl. No.: 13/363,997

(22) Filed: Feb. 1, 2012

Related U.S. Application Data
(63) Continuation-in-part of application No. 13/112,047, filed on May 20, 2011.

(51) Int. Cl. F25B 21/02; B32B 37/00; B21D 53/02

(52) U.S. Cl. 62/3.7; 29/890.03; 156/60

(57) ABSTRACT

A device for conducting heat from a source to a sink is provided that, in one embodiment, includes a thermoelectric element coupled to a substrate via sintered material that includes nano and/or micro particles. In one aspect, the sintered material includes silver particles and in another aspect the sintered material also includes an additive to control the coefficient of thermal expansion of the sintered material.

### CROSS-REFERENCE TO RELATED APPLICATIONS

This application is a continuation-in-part of the U.S. patent application having the Ser. No. 13/112,047 filed May 20, 2011.

### BACKGROUND INFORMATION

1. Field of the Disclosure

This disclosure relates generally to devices for use in high temperature environments, including, but not limited to, thermoelectric devices for conducting heat away from or to payloads.

2. Brief Description of the Related Art

Electronics components such as hybrid circuits are commonly used in tools made for use in high temperature environments, such as deep oil wells. Current drilling and logging systems include sensors and devices that utilize electronic devices and circuits to obtain a variety of measurements to determine various parameters for the formation and to evaluate and monitor drilling and wireline operations. Severe downhole environmental conditions, such as temperatures up to 300° C. and wellbore depths up to 10,000 meters, make high demands on the materials and electronics used for measurement-while-drilling (MWD) and wireline tools. Thermoelectric coolers, based on the Peltier effect, have been considered to remove heat from hybrid circuit boards used for downhole electronic circuits to maintain circuit temperatures and board temperatures about 50° C. below the ambient temperature of 200° C. However, the bonding materials, such as solders (e.g., Sn95/Sb5), often used for the assembly of bismuth telluride (Bi₂Te₃)-based thermoelectric coolers can endure temperatures of approximately 230° C., limiting the use of commonly used thermoelectric materials. In addition, there is a mismatch in the coefficient of thermal expansion (“CTE”) between the solder material and the thermoelectric materials, especially high-temperature-stable silicon-germanium (SiGe) which is commonly used as the substrate. Also, low temperature range of Bi₂Te₃ can cause failures during temperature cycling often performed to improve reliability of the assembled electric circuits and devices.

The disclosure provides an improved apparatus and method for conducting heat that utilize silver sintered bonding materials.

### SUMMARY

In one aspect, the present disclosure provides a method of joining a thermoelectric device to a member, including: providing a bonding material that includes at least one of micro particles and nano particles between the thermoelectric device and the member; and sintering the bonding material to join the thermoelectric device to the member.

In another aspect, the present disclosure provides a device for transferring heat that includes a thermoelectric device configured to transfer heat; and a member attached to the thermoelectric device via a sintered bonding material, wherein the sintered bonding material includes at least one of micro and nano particles.

In another aspect, the present disclosure provides a device for conducting heat, the device including: a thermoelectric element having a first side and a second side; a first substrate; and a first silver-sintered bonding layer between the first side of the thermoelectric element and the first substrate configured to bond the thermoelectric element to the first substrate.

In another aspect, the present disclosure provides a method of providing a heat transfer device that includes: providing a thermoelectric element having a first side and a second side; attaching a first substrate to the first side of the thermoelectric element by a first silver-sintered bonding layer; and attaching a second substrate to the second side of the thermoelectric element by a second silver-sintered bonding layer.

Examples of certain features of the apparatus and method disclosed herein are summarized rather broadly in order that the detailed description thereof that follows may be better understood. There are, of course, additional features of the apparatus and method disclosed hereinafter that will form the subject of the claims appended hereto.

### BRIEF DESCRIPTION OF THE DRAWINGS

For detailed understanding of the present disclosure, references should be made to the following detailed description, taken in conjunction with the accompanying drawings in which like elements have generally been designated with like numerals and wherein:

FIG. 1 shows a die for attachment to a substrate using a bonding material comprising silver nano and micro particles;

FIG. 2 shows an exemplary system for attaching a die to a substrate using a bonding material comprising nano and micro silver particles;

FIG. 3 shows shear strength, porosity and Young's Modulus of bonding between a die attached to a silicone substrate formed according to a method described herein for bonding materials containing 0% to 100% nano silver particles by weight;

FIG. 4 shows an exemplary heat conducting device utilizing Peltier effect, according to one embodiment of the disclosure; and

FIG. 5 shows a relationship between the composition of silver and diamond particles and the coefficient of thermal expansion of a sintered layer made from such a mixture.

### DETAILED DESCRIPTION

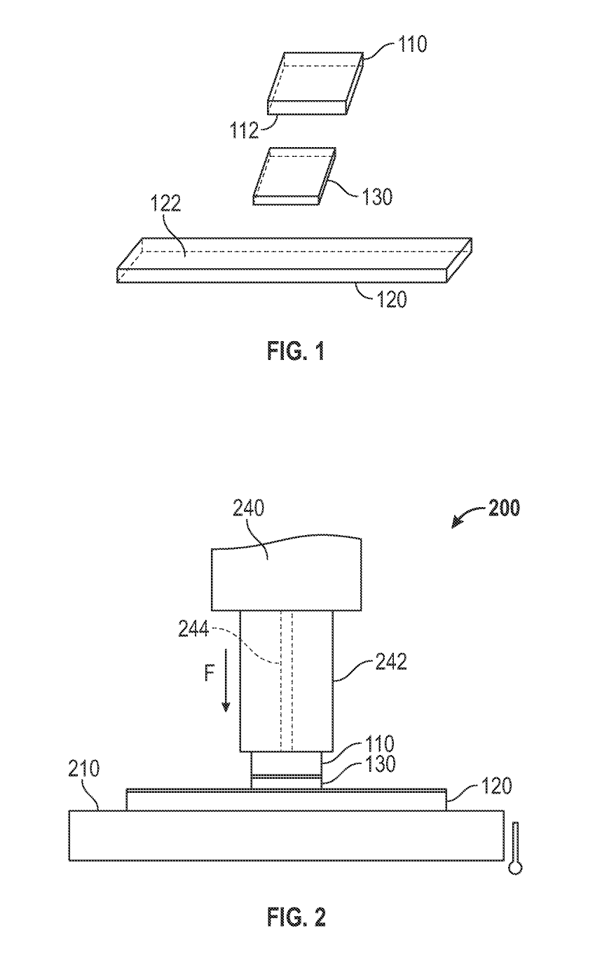

The present disclosure, in aspect, relates to joining or attaching members using a sintered bonding material that in aspects may include a mixture of nano particles and micro particles of one or more materials. FIG. 1 shows exemplary members that may be joined or attached to each other according to one embodiment of the disclosure. FIG. 1 shows a member (also referred to as a “die”) 110 that is to be attached to another member (also referred to as a “substrate”) 120 using a bonding material 130. In one aspect, the die 110 may be any suitable member or component, including but not limited to, an electronic component, such as an integrated circuit, transistor, a power component, and an optoelectronic component, such as a light emitting diode, a photo diode or another suitable component. The substrate 120 may be made from any suitable material, including, but not limited to a ceramic material, such as aluminum oxide (Al₂O₃), a metallic material and a semiconducting material (such as silicon, Bi₂Te₃). In one exemplary embodiment, the bonding material 130 is a mixture of nano silver particles and micro silver particles. The bonding material 130 may be in any suitable form, including but not limited to, paste, powder, etc. The nano silver particles and micro silver particles may be of any suitable shape, including, but not limited to spheres and flakes. To attach the die 110 to the substrate 120, the attaching surface 112 of the die 110 and the attaching surface 122 of the substrate are cleaned. The bonding material 130 is then applied to one of the surfaces 112 and 122. The die 110 is then placed on the substrate 120. A suitable pressure is applied on the die and/or substrate while heating the bonding material 130, such as by heating the substrate and/or die to a suitable temperature for a selected time period to sinter the bonding material 130. The heat is then removed, thereby attaching the die 110 to the substrate 120.

FIG. 2 shows an exemplary apparatus 200 for attaching a die 110 to a substrate 120 using a bonding material 130 comprising a mixture of nano silver particles and micro silver particles. The system 200 of FIG. 2 is shown to include a base plate 210 that may be heated to a temperature sufficient to sinter the selected bonding material and a handling device 240. The sinter temperature of the bonding material is less than the operating temperature of the die and the substrate. The handling device 240, in one embodiment, may include an arm 242 configured to be pressed against the base plate 210 by a suitable mechanism, such as a hydraulically-operated unit, an electrically-operated unit or a pneumatically-operated unit. The system 200 is configured in a manner such that it can apply a relatively precise pressure on the arm 242 and thus also on the base plate 210. In aspects, device 240 may be configured to apply pressure in excess of 40 N/mm². In one configuration, the device 240 includes a vacuum suction mechanism 244 configured to pick up a component, such as die 110. An exemplary process of joining the die 110 to a substrate 120 is described below. A surface of one of the die and substrate 120 is coated with the bonding material 130. The substrate 120 is securely placed on the base plate 210. The die is picked up by arm 242 using the vacuum suction 244. The arm 242 may be positioned aided by the use of an optical microscope and an x-y positioning table (not shown) over the base plate 210. The arm 242 is then moved downward till the die 110 with the bonding material 130 contacts the base plate 210. The movement and placement of the joining members 110 and 120 may be observed simultaneously via a suitable vision alignment system (not shown). The joining members 110 and 120 are heated by heating the base plate 210 to a selected temperature. A contact force “F” is applied to the die 110 and substrate 120 by the arm 242, which force may be varied during the bonding process. In aspects, the contact force F may be applied uniaxially or quasi-hydrostatically. In one aspect, the handling device 242 may be made of silicone and of different hardness. Other suitable materials include stainless steel, temperature-stable and pressure-stable soft plastics, such as polyether ether ketone (PEEK), etc. In aspects, a material with low thermal conductivity is used in order to prevent the cooling of the joining surfaces during the joining process. The use of a soft-contact material, such as silicone, compensates for uneven surfaces. This improves reproducibility and the process capability index (CpK) of the bonding process. The use of silicone also avoids surface damage. The base plate 210 is heated to a desired temperature while applying the selected pressure until the bonding material of silver nano particles and silver micro particles sinters. The temperature is then lowered and pressure on the die 110 is relieved. In aspects, the joining process described above may utilize pressure between 0 to 40 MPa at a temperature between 130 C and 350 C for a period of 1 minute to 120 minutes. The above-noted process can provide stable die attachment for operations exceeding 350 C.

In one aspect, the sintering process described herein may be utilized for joining components, such as for attaching electronic components on substrates to form hybrid circuits, which may be achieved by modifying the die attachments mechanism of a commercially available flip-chip bonder, an apparatus used for micro assembly of dies on substrates in the electronic industry. The joining process described herein allows a relatively precise pick-and-place bonding of a die (e.g. transistors, bumped devices for flip-chip die attachment, memory chips, LEDs, sensor, etc.) to an application-specific carrier. This process may also be used for die stacking and three-dimensional (3D) assemblies of electronic components. For example, memory devices and light emitting diodes (LEDs) may be bonded on a thermoelectric device, such as a device using Peltier effect (also referred to herein as “Peltier device”), to transfer heat from such devices to a heat sink to provide stable operation of such heat-generating devices. In other aspects the methods described herein may be used to transfer heat to a device to maintain temperature of such device at selected levels. Also, the described joining process may be used for the assembly of chip packages on substrates.

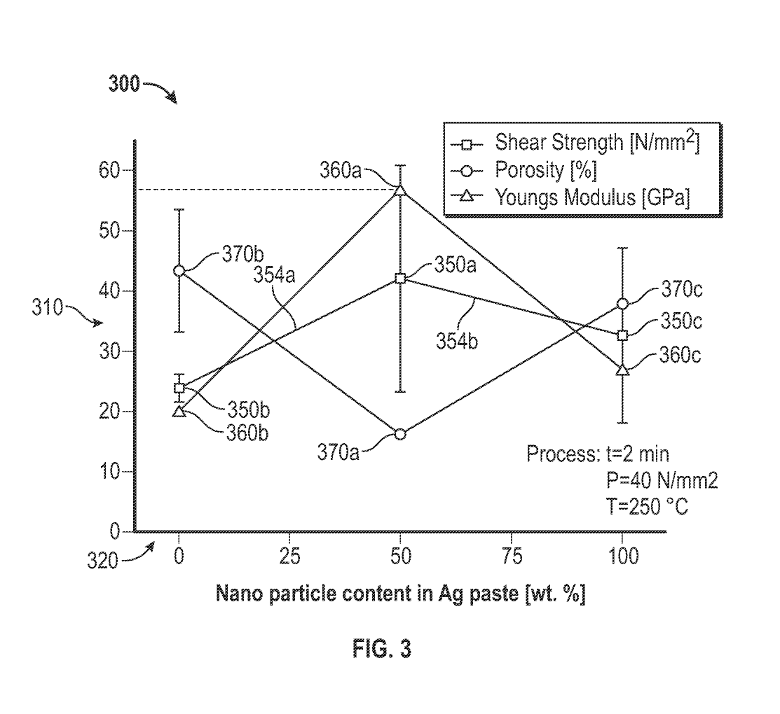

FIG. 3 shows graphs 300 depicting shear strength, porosity and Young's Modulus measured during a laboratory test of an electronic chip (die) bonded onto a silicon substrate according to a method described herein, using a bonding material containing (i) only silver micro particles; (ii) 50% by weight silver nano particle, and (iii) 100% silver nano particles. The vertical scale 310 corresponds to shear force in N/mm², porosity in percentage and Young's Modulus in GPa. The horizontal axis corresponds to the percent of nano sized particles of silver by weight in the bonding material. The dies used for testing were formed by bonding a die on a silicon substrate using an applied pressure of 40 N/mm², the base plate temperature of 250° C. for 2 minutes. FIG. 3 shows that shear strength 350a for the bonding material containing 50% by weight each of the silver nano particles and silver micro particles is about 56 N/mm²; shear strength 350b for a bonding material containing no silver nano particles (i.e. material containing all silver micro particles) is about 23 N/mm²; and for a bonding material containing all silver nano-particles the shear strength is about 32 N/mm². Extrapolations shown by lines 354a and 354b indicate that the shear strength of components joined by a bonding material containing a mixture of silver nano particles and silver micro components is greater than shear strength obtained by a bonding material containing no silver nano particles. Also, shear strength for 100% nano silver nano particles is greater than shear strength for 100% silver micro particles (32 N/mm² versus 23 N/mm² for the specific case shown in FIG. 3). Shear strength is a measure used to determine suitability of a bonding material for joining electronics components to substrates. Young's modulus, which is a ratio of the stress (tensile load) applied to a material and the strain (elongation) exhibited by the material due to the applied stress, is another measure of a desired physical property of a material. It is known that higher the Young's Modulus, the higher the stiffness. FIG. 3 shows that the Young's Modulus for bonding material containing 50% of silver nano particles and 50% of silver micro particles 360a (55 GPa) is greater than the Young's Modulus 360c (27 GPa) for a bonding material containing 100% silver nano particles, that, in turn is greater than the Young's Modulus 360b (20 GPa) for a bonding material containing 100% silver micro particles. Thus, in the specific cases shown in FIG. 3, the attachment for sintered silver bonding material containing a mixture of silver nano particles and silver micro particles or 100% silver nano particles is stiffer than the bonding material containing 100% micro particles. Additionally, porosity 370a for a bonding material containing about 50%-50% mixture of nano silver particles and micro silver particles (16%) is lower than porosity 370c for 100% nano particles (38%), which is lower than porosity 370b for 100% micro silver particles (43%). FIG. 3 shows that the porosity for a bonding mixture containing nano silver particles and micro silver particles is lower than porosity of a bonding material containing all micro silver particles. In general, the lower the porosity, the stronger is the bond. The above test data shows that a bonding material having a mixture of silver nano particles and micro particles is more suitable or desirable when bonding components using silver sintering. The particular test data shown in FIG. 3 is provided for ease of understanding and is not to be considered a limitation.

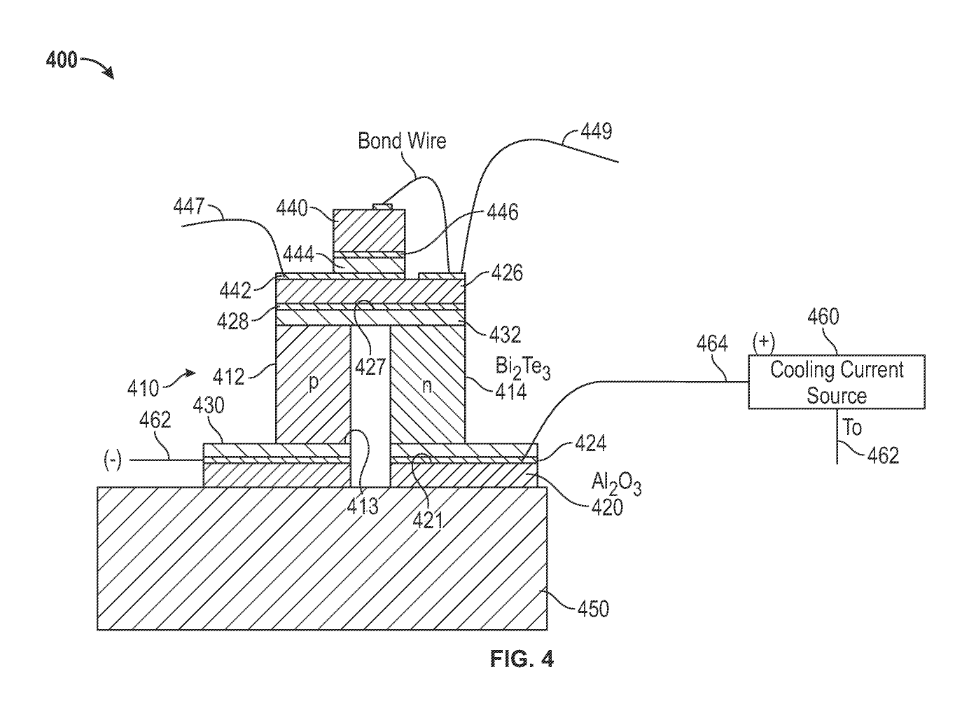

FIG. 4 shows an exemplary heat conducting or heat transfer device 400, utilizing a thermoelectric device, made according to one embodiment of the disclosure. The device 400 includes a thermoelectric element (also referred to herein as a “Peltier element) 410 that includes one or more p-doped elements 412 and one or more n-doped elements 414. In one embodiment, elements 412 and 414 may be made from bismuth telluride (Bi₂Te₃). The device 400 includes a first substrate 420 made from a suitable material, such as aluminum oxide (Al₂O₃). A side 421 of the substrate includes a conductive layer 424 made from a suitable material, such as a composition of titanium, palladium and gold. Other materials may also be used to form layer 421 for the purpose of this disclosure. A first side 413 of the Peltier element 410 is bonded to the conductive layer 424 via a sintered-silver layer 430 according to one of the methods described herein. A second substrate 426 is coupled or attached to a second side 427 of a second substrate 420 via a conductive layer 428 and a silvered-sintered layer 432. In one embodiment, a heat generating device 440, for example a light emitting diode or another device, may be connected to the substrate 426 via a conductive layer 442 on the substrate 430, sintered-silver layer 444 and another conductive layer 446. In aspects, a heat sink 450, such as an aluminum block, may be attached to the substrate 420 to conduct heat from the Peltier element 410 to the heat sink 450. Leads 447 and 449 connect circuitry to the device 440. In the particular embodiment of FIG. 4, current from a source 460 may be applied to the Peltier element 410 to cause the heat to flow from the Peltier element 410 to the heat sink 450. In such a mode, the p-doped element 412 is connected to the negative side 462 of the current source 460 while the n-doped element 414 is connected to the positive side 464 of the source 460. To move or transfer heat from the heat generating device 440 (heat source) to the heat sink 450, the current is applied to the Peltier element 410, which causes the heat to move from the source 440 to the sink 450. In some cases, it may be desired to supply heat to a device so as to maintain such device at a constant or near constant temperature. In such a case, the current polarities for the Peltier element 410 may be reversed to cause the heat to flow from a heat source attached to substrate 420 to the device 440.

The embodiment of device 400 shown in FIG. 4 is a particular embodiment of a thermoelectric module. Other devices or elements may be bonded via sintered layers utilizing the methods described herein. In general, in such applications a relatively thin layer of a bonding material, such as silver, serves as a bonding material or glue between a device and a substrate. Silver has a very high melting point (962 degrees Centigrade) and relatively high thermal conductivity (429W/mK at 200K). The silver-sintered layer thus provides an efficient path for conducing heat between adjoining members, such as a device and a substrate. In general, the performance of a silver-sintered bonding layer increases with the pressure applied to attach the die and the substrate. However, for materials, such as bismuth telluride crystals used as Peltier elements, low pressure can be maintained to obtain a fracture-free bond useful for high temperature downhole applications. For rough surface areas (for example, surface areas having Ra>5 micrometers), a relatively thick bonding layer (for example a layer having thickness greater than 70 micrometers) and having low viscosity may be used to compensate for crystal surface roughness and to provide a relatively large bonding surface for desired adhesion. For crystal or device surfaces that may include non-noble metals, such as Nickel, such surfaces may be deposited with a noble metal material, such as titanium/palladium/gold, as shown in FIG. 4.

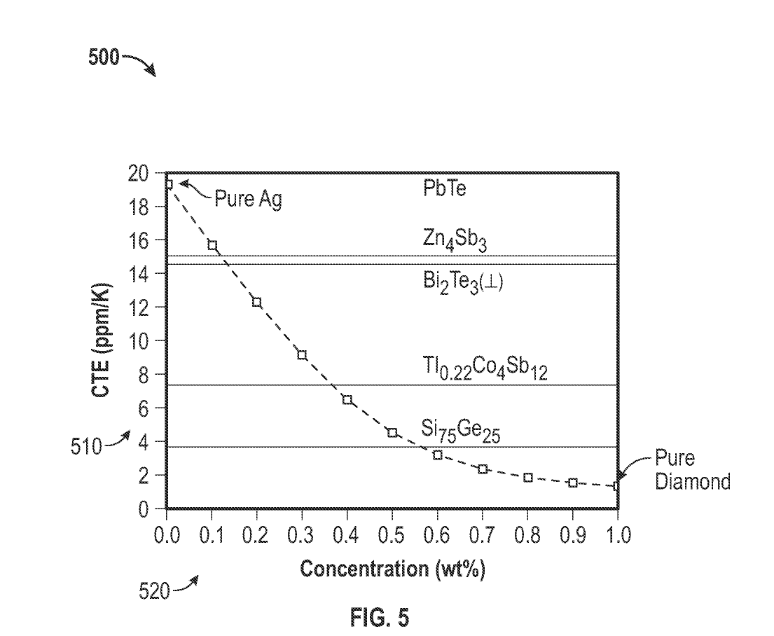

Thermoelectric substrates, such as made from aluminum oxide or silicon and germanium (SiGe) have low coefficients of thermal expansion (“CTE”) compared to silver and thus it is desirable to reduce the CTE of the silver-sintered layer to reduce or minimize thermally induced stresses in the crystal bonded to the substrate to avoid cracking of the crystal. Such compatibility between thermal expansion coefficients becomes more important when relatively thick bonding layers (for example, greater than 50 micrometers) are used. To reduce the CTE of the silver-sintered layer, a suitable additive may be added to the silver particles. In one aspect, selected amounts by weight or volume of diamond micro particles (for example, about 1 micrometer in size) and/or nano particles (for example, about 10 nanometers in size) may be added to the silver particles. Diamond particles have very low CTE (about 1 ppm/K) and very high thermal conductivity (between 1000 and 2000 W/mK). FIG. 5 shows a graph or relationship 500 between the amount of diamond particles by weight in silver particles and the CTE of a sintered layer made from such mixtures. The vertical axis shows the CTE (ppm/K) and the horizontal axis shows the diamond particle concentration percentage by weight. The diamond particles may be homogeneously distributed in the silver particles to obtain a relatively uniform sintered bonding layer. FIG. 5 also indicates the CTE of various compound used in the electronic industry, such as Zn₄Sb₃, Bi₂Te₃, Ti_{0.22}Co₄Sb₁₂, Si75Ge25, pure silver and pure diamond. FIG. 5 shows that the CTE for a silver-sintered bonding layer that includes about 50% diamond micro and nano particles is about the same as the CTE for a Silicon-Germanium (Si75Ge25) substrate. Thus, in aspects, a selected amount of an additive, such as diamond particles, may be homogeneously mixed with silver particles to form the silver-sintered bonding layer to match or substantially match the CTE of the bonding layer with the CTE of a member or device.

In other aspects, the porosity of the silver-sintered bonding layer increases with the concentration of the diamond particles with a tendency toward saturation at about 60% of diamond particles by weight. In some applications, it is desirable to reduce the porosity for the sintered bonding layer. In such cases, by adding diamond nano particles in silver particles instead of diamond micro particles, a higher filling degree can be achieved with lower porosity. Also, since diamond nano particles result in lowering the porosity of the mixture, a sintered layer made from such a mixture also exhibits higher thermal conductivity. Thus, in aspects, an additive, such as diamond nano and micro particles may be added to achieve a selected ratio between the silver and diamond particles so as to obtain a sintered bonding layer that has the desired CTE, porosity and thermal conductivity.

Thus, in one aspect, a method of attaching members is provided. In one aspect, the method includes placing a bonding material comprising a mixture of silver particles of micrometer size (micro particles) and/or nanometer size (nano particles) on a surface of a first member; placing the first member with the surface of the first member having the mixture on a surface of a second member; heating the bonding material to a selected temperature while applying a selected pressure on at least one of the first and second members for a selected time period to sinter the bonding material to attach the first member to the second member. In one aspect, the silver nano particles in the bonding material are about fifty percent (50%) by weight. In another aspect, an additive may be added to the silver particles to alter at least one of CTE, porosity and thermal conductivity of the sintered bonding layer.

In one aspect, a device made according to one embodiment of this disclosure includes a substrate and a die bonded onto the substrate by sintering a bonding material that contains silver micro particles and/or silver nano particles onto the substrate. In aspects, the bonding material may include silver nano particles between 0% and 100% by weight. The substrate may be made from any suitable material, including silicon dioxide, aluminum dioxide, silicon-germanium, etc.

In another aspect, a device is provided that in one embodiment includes a Peltier element bonded to a substrate via a silver sintered layer. The device may further include a heat source that provides heat to the Peltier element and a heat sink that draws heat away from the peltier element. In another aspect, the silver-sintered layer may include an additive that reduces the CTE of the bonding layer.

In another aspect, the disclosure provides a device for conducting heat that includes a bonding layer made according one embodiment of the disclosure. A particular embodiment of such a device includes a Peltier element having a first side and a second side, a first substrate, and a first silver-sintered bonding layer between the first side of the thermoelectric element and the first substrate to bond the thermoelectric element to the substrate and to transfer heat from the thermoelectric element to the substrate. In another aspect, the device may further include a second substrate and a second silver-sintered layer between the second side of the thermoelectric element and the second substrate to bond the thermoelectric element to the second substrate and to transfer heat from the second substrate to the thermoelectric element. In yet another aspect, the thermoelectric element includes a p-doped member and an n-doped member. The first substrate may include a base member and a conductive member thereon and wherein the first sintered silver layer is bonded to the conductive member on the first substrate. The device may further include a heat sink coupled to the first substrate for draining heat from the first substrate. The device may further include a heat generating element coupled to the second substrate via a third silver sintered layer. In aspects, the silver-sintered layer may include nano silver particles and/or micro silver particles. The silver-sintered layer may also include a selected additive that reduces the CTE of the silver-sintered layer. The additive may be diamond nano and/or micro particles. In one embodiment the diamond particles comprise about 50% of the weight of the bonding mixture. In another aspect, the amount of the additive is selected so that the CTE of the sintered bonding layer is substantially the same as the CTE of the substrate. In another aspect, the device further includes a source of supplying current to the peltier element to cause the heat to conduct from the thermoelectric element to the first substrate or from the first substrate to the thermoelectric element.

In yet another aspect, the disclosure provides a method of forming a heat conducting device that includes: providing a Peltier element; and attaching a substrate to the Peltier element via a silvered sintered layer. The silver-sintered layer may include silver nano particles and/or micro particles. The silver-sintered layer may also include an additive for controlling the CTE of the silver-sintered layer.

In one aspect, the present disclosure provides a method of joining a thermoelectric device to a member, including: providing a bonding material that includes at least one of micro particles and nano particles between the thermoelectric device and the member; and sintering the bonding material to join the thermoelectric device to the member. In one embodiment the bonding material includes silver particles. The bonding material may further include an additive that controls a coefficient of thermal expansion of the bonding material. In one embodiment, the additive is diamond powder. The bonding material may include an additive that enhances a thermal conductivity of the bonding material.

In another aspect, the present disclosure provides a device for transferring heat that includes a thermoelectric device configured to transfer heat; and a member attached to the thermoelectric device via a sintered bonding material, wherein the sintered bonding material includes at least one of micro and nano particles. In one embodiment, the bonding material includes silver particles. The bonding material may include an additive that controls a coefficient of thermal expansion of the bonding material. In one embodiment, the additive controlling the coefficient of thermal expansion is diamond powder. The bonding material may further include an additive configured to enhance a thermal conductivity of the bonding material.

In another aspect, the present disclosure provides a device for conducting heat, the device including: a thermoelectric element having a first side and a second side; a first substrate; and a first silver-sintered bonding layer between the first side of the thermoelectric element and the first substrate configured to bond the thermoelectric element to the first substrate. The device may further include a second substrate; and a second silver-sintered layer between the second side of the thermoelectric element and the second substrate configured to bond the thermoelectric element to the second substrate. In one embodiment, the thermoelectric element includes a p-doped member and an n-doped member. In one embodiment, the first substrate includes a base member and a conductive member thereon and wherein the first sintered-silver layer is bonded to the conductive member on the first substrate. The device may include a heat sink coupled to the first substrate configured to drain heat from the first substrate. The device may also include a heat-generating element coupled to the second substrate via a third silver-sintered layer. In various embodiments, the first silver-sintered layer includes one of nano silver particles and micro silver particles. The first silver-sintered layer may include a selected additive that alters one of coefficient of thermal expansion and porosity of the first silver-sintered layer. The device may further include a current source configured to supply current to the thermoelectric element to conduct heat as one of: (i) from the thermoelectric element to the first substrate; and (ii) from the first substrate to the thermoelectric element.

In another aspect, the present disclosure provides a method of providing a heat transfer device that includes: providing a thermoelectric element having a first side and a second side; attaching a first substrate to the first side of the thermoelectric element by a first silver-sintered bonding layer; and attaching a second substrate to the second side of the thermoelectric element by a second silver-sintered bonding layer. The method may further include coupling a heat source to one of the first and second substrates and a heat sink to the other of the first and second substrates. The method may further include providing a current to the thermoelectric element to transfer heat from the heat source to the heat sink.

The foregoing description is directed to particular embodiments for the purpose of illustration and explanation. It will be apparent, however, to persons skilled in the art that many modifications and changes to the embodiments set forth above may be made without departing from the scope and spirit of the concepts and embodiments disclosed herein. It is intended that the following claims be interpreted to embrace all such modifications and changes.

1. A method of joining a thermoelectric device to a member, comprising:
providing a bonding material that includes at least one of micro particles and nano particles between the thermoelectric device and the member; and
sintering the bonding material to join the thermoelectric device to the member.

2. The method of claim 1, wherein the bonding material includes silver particles.

3. The method of claim 2, wherein the bonding material further includes an additive that controls a coefficient of thermal expansion of the bonding material.

4. The method of claim 3, wherein the additive is diamond powder.

5. The method of claim 1, wherein the bonding material includes an additive that enhances a thermal conductivity of the bonding material.

6. A device for transferring heat, comprising:
a thermoelectric device configured to transfer heat; and
a member attached to the thermoelectric device via a sintered bonding material, wherein the sintered bonding material includes at least one of micro and nano particles.

7. The device of claim 6, wherein the bonding material includes silver particles.

8. The device of claim 6, wherein the bonding material includes an additive that controls a coefficient of thermal expansion of the bonding material.

9. The device of claim 8, wherein the additive is diamond powder.

10. The device of claim 6, wherein the bonding material further includes an additive configured to enhance a thermal conductivity of the bonding material.

11. A device for conducting heat, comprising:
a thermoelectric element having a first side and a second side;
a first substrate; and
a first silver-sintered bonding layer between the first side of the thermoelectric element and the first substrate configured to bond the thermoelectric element to the first substrate.

12. The device of claim 11 further comprising:
a second substrate; and
a second silver-sintered layer between the second side of the thermoelectric element and the second substrate configured to bond the thermoelectric element to the second substrate.

13. The device of claim 11, wherein the thermoelectric element includes a p-doped member and an n-doped member.

14. The device of claim 11, wherein the first substrate includes a base member and a conductive member thereon and wherein the first sintered-silver layer is bonded to the conductive member on the first substrate.

15. The device of claim 11 further comprising a heat sink coupled to the first substrate configured to drain heat from the first substrate.

16. The device of claim 12 further comprising a heat-generating element coupled to the second substrate via a third silver-sintered layer.

17. The device of claim 11, wherein the first silver-sintered layer includes one of nano silver particles and micro silver particles.

18. The device of claim 17, wherein the first silver-sintered layer further includes a selected additive that alters one of coefficient of thermal expansion and porosity of the first silver-sintered layer.

19. The device of claim 11 further comprising a current source configured to supply current to the thermoelectric element to conduct heat as one of: (i) from the thermoelectric element to the first substrate; and (ii) from the first substrate to the thermoelectric element.

20. A method of providing a heat transfer device, comprising:
providing a thermoelectric element having a first side and a second side;
attaching a first substrate to the first side of the thermoelectric element by a first silver-sintered bonding layer; and
attaching a second substrate to the second side of the thermoelectric element by a second silver-sintered bonding layer.

21. The method of claim 20 further comprising coupling a heat source to one of the first and second substrates and a heat sink to the other of the first and second substrates.

22. The method of claim 21 further comprising providing a current to the thermoelectric element to transfer heat from the heat source to the heat sink.
